(19) United States
(12) Patent Application Publication
(10) Pub. No.: US 2008/0082486 A1
(43) Pub. Date: Apr. 3, 2008

(54) Platform for user discovery experience

(75) Inventors: Pierre Lermant, Sunnyvale, CA (US); Jason Douglas, San Francisco, CA (US)

Correspondence Address: Dreier LLP, 499 Park Avenue, New York, NY, 10022, US

(73) Assignee: Yahoo! Inc., Sunnyvale, CA (US)

(21) Appl. No.: 11/529,841

(22) Filed: Sep. 29, 2006

(51) Int. Cl. G06F 17/30

(52) U.S. Cl. 707/3

(57) ABSTRACT

The present invention is directed towards a platform for user discovery. A method according to one embodiment of the invention comprises receiving a request from a user to initiate a search for content items previously indexed and associated with one or more tags by a community of users and identifying a set of preliminary tags from an index of tags defined by the community, where each tag is associated with one or more content items. Input is received from the user of at least one tag or keyword to update a current set of selected tags and keywords and identify a result set of content items having associated tags and keywords matching the current set of selected tags and keywords. The result set of content items is presented along with an intermediate set of tags to serve as a potential starting point for refining the search based on the tags associated with each of the content items in the result set.

### COPYRIGHT NOTICE

A portion of the disclosure of this patent document contains material subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF THE INVENTION

The present invention generally provides methods and systems for facilitating identification of content items such as web pages and web feeds. More specifically, the present invention provides methods and systems for facilitating the search and retrieval of content items (such as web pages and web feeds) using adaptive content categorization based on descriptions and attributes of the content items, e.g., tags.

### BACKGROUND OF THE INVENTION

A number of techniques are known to those of skill in the art for organizing content items such as web pages and web feeds for subsequent search and retrieval through a web browser. Web pages and web feeds may relate to a wide variety of topics such as art, music, news, politics, sports, etc. They may also be described by various keywords. In many cases, a given content item may be organized according to one or more categories as well as one or more keywords or descriptors. As such, many browser-based search mechanisms involve either category-based organization and search or keyword-based organization and search.

Using a category-based organization and search technique, human editors or machines assign specific content items to various categories according to a hierarchical category structure. Users may browse through specific categories to identify relevant content items of interest. In the case where humans edit the categories, such technique may be manpower-intensive. New categories must be added (e.g., the advent of podcasts as a viable category) and updated (e.g., adding and removing content items). Also, the hierarchical organization may be unreliable due to the subjective nature of the categorization. For instance, some groupings that are designated as sub-categories may also be viable as root categories, making navigation from the general to the more specific uncertain. For example, the grouping “blog” may qualify both as a root category as well as a sub-category of a “news” category. As a result of such limitations, the amount of content searchable through category-based browsing is generally small in relation to the amount of content available.

Using a keyword-based organization and search technique, content items are not organized per se. Instead, a user provides a set of keywords to a search engine that identifies content items containing the keywords. Such a technique may produce unwanted or irrelevant results where keywords bear multiple different meanings in different contexts. For example, the keyword “sharks” may refer both to the animal and the professional hockey team San Jose Sharks. Also, such a technique may fail to identify otherwise relevant content where the specific keywords are not present.

Thus, there exists a need for systems and methods that incorporate benefits of both keyword-based searching and category-based searching when conducting searches over a corpus of content items.

### SUMMARY OF THE INVENTION

Embodiments of the present invention provide systems and methods for facilitating identification of content items such as web pages and web feeds using adaptive content categorization. One embodiment of a method involves receiving a request from a user to initiate a search for content items previously indexed and associated with one or more tags by a community of users and identifying a set of preliminary tags from an index of tags defined by the community, where each tag is associated with one or more content items. The preliminary tags may be identified based on the popularity of each tag in the index. Alternatively, or in conjunction with the foregoing, preliminary tags may be identified through the use of human editors, interest derived from past searches of a given user and browsing behavior over a set of tags for a given user. The method further involves presenting the set of preliminary tags to serve as a potential starting point for the search and receiving input from the user of at least one tag or keyword to update a current set of selected tags and keywords. The user may add or remove tags and keywords from the currently selected set of tags and keywords.

The method further involves identifying a result set of content items having associated tags and keywords matching the current set of selected tags and keywords and presenting the result set of content items along with an intermediate set of tags to serve as a potential starting point for refining the search based on the tags associated with each of the content items in the result set. The method may further involve repeating the steps of receiving input from the user of at least one tag or keyword, identifying a result set of content items having associated tags and keywords matching the current set of selected tags and keywords, and presenting the result set of along with an intermediate set of tags to serve as a potential starting point for refining the search based on the tags associated with each of the content items in the result set. Submitting a search without any selected tags or keywords may also start the method.

One embodiment of a system includes an index of content items, an index of tags, index of keywords and a search engine. Each tag is associated with at least one content item. The search engine is operative to identify a result set of content items based on matching tags selected by a user. The search engine is also operative to suggest tags for a user to select based on the result set for the purpose of refining a search. A community of users may define the index of tags. The system may also include a tag ranker operative to rank tags associated with content items. The tag ranker may rank tags based on a measure of popularity of each tag. For example, the number of users using the tag, the number of users associating the tag with a given content item, or the number of content items having associated with it the tag may measure the popularity of a given tag.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 is a block diagram presenting a system for facilitating search and retrieval of content items using adaptive content categorization according to one embodiment of the present invention;

FIG. 2 is a flow diagram presenting a method for processing a search request using adaptive content categorization according to one embodiment of the present invention; and

FIGS. 3A through 3D are screen diagrams presenting a user interface for searching and retrieving content items using adaptive content categorization according to one embodiment of the present invention.

### DETAILED DESCRIPTION OF PREFERRED EMBODIMENTS

In the following detailed description, reference is made to the accompanying drawings that form a part hereof, and in which is shown by way of illustration a specific embodiment in which the invention may be practiced. It is to be understood that other embodiments may be utilized and structural changes may be made without departing from the scope of the present invention.

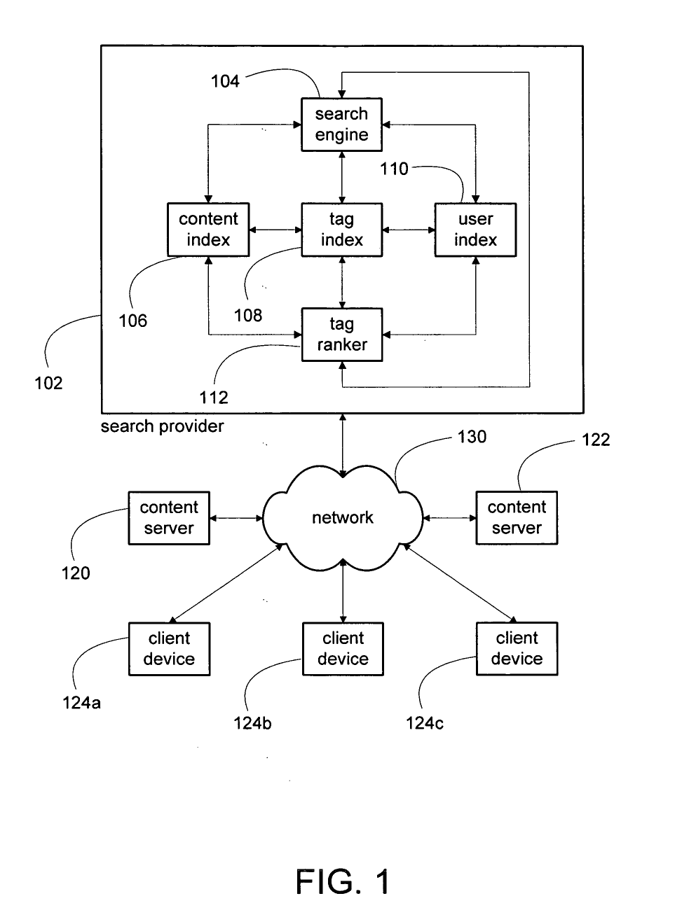

FIG. 1 presents a block diagram illustrating one embodiment of a system for facilitating search and retrieval of content items using adaptive content categorization. The system of the present embodiment includes one or more content servers 120 and 122 and client devices 124a, 124b, and 124c (hereinafter each identified as client device 124) coupled via a network 130 to a search provider 102. The network may comprise combinations of one or more local and wide area networks, e.g., the Internet. Client device 124 may be any device that allows for transmission of commands and requests to search provider 102, such as content search requests as well as tagging commands. Client device 124 also allows for the receipt and display of ranked search result sets from the search provider 102. Client device 124 may be a general-purpose computer comprising a processor, transient and persistent storage devices, an input/output subsystem, and a bus to provide a communications path. Client device 124 may have a network interface to the network 130, such as a wired or wireless Ethernet interface. Client device 124 may also run software applications such as a web browsing application, which according to one embodiment provides for access to the search provider 102. Exemplary client devices 124 include, but are not limited to, laptop computers, personal digital assistants (PDAs), mobile phones, desktop computers, etc.

According to the embodiment of FIG. 1, a search provider 102 includes search engine 104 coupled to content index 106, to tag index 108, and to user index 110. The search provider further includes a tag ranker 112 coupled to search engine 104, to content index 106, to tag index 108, and to user index 110. Content servers 120 and 122 provide content items including, but not limited to, web pages and RSS feeds. Content index 106 maintains an index of content items that the content servers 120 and 122 provide. Exemplary methods for indexing content items is described in commonly owned U.S. patent application Ser. No. 5,745,889, entitled “METHOD FOR PARSING INFORMATION OF DATABASE RECORDS USING WORD-LOCATION PAIRS AND METAWORD-LOCATION PAIRS,” the disclosure of which is hereby incorporated by reference in its entirety. User index 110 indexes registered users of search provider 102.

Tag index 108 indexes tags, where each tag may be associated with one or more content items indexed in content index 106 and may be associated with one or more users indexed in user index 110. Using the network 130, the search provider 102 is operative to access content items on more or more content servers 120 and 122. A user operating a client device 124 interacts with search provider 102 to identify and access content items indexed in content index 110 and stored on content servers 120 and 122. Once the user accesses a given content item, the user may tag the content item with one or more tags that categorize or describe the content item. Such tags are stored in the tag index 108. Each tag in tax index 108 may be associated with one or more content items indexed in content index 106 as well as with one or more users indexed in user index 110.

Search engine 104 receives and processes search requests from users operating client devices 124 and identifies content items indexed in content index 106 having certain attributes, such as matching keywords and community-defined tags. The search engine 104 presents a user with a results set of content items and may suggest tags to the user in order to further refine a search request. The search engine 104 may suggest tags based on tag rankings provided by the tag ranker 112. The tag ranker 112 may be seeded with one or more content items, e.g., RSS feeds, and tags associated with the one or more content items from the tag index 108.

According to one embodiment, the tag ranker 112 weights a given tag in accordance with a popularity for the content item with which the tag is associated (e.g., the number of saves of the content items at a bookmarking services such as Del.icio.us or Yahoo's MyWeb 2.0) and the number of users who have tagged the content item with the given tag. Stemming may be employed to cut out tags that have a low number of users that utilize the tags. The tag ranker 112 provides the weighted tags to the search engine 104 for presentation to the user, although other components may present the weighted tags to the user.

The search engine 104 allows the user to select zero or more of the presented tags, as well as provide zero or more keywords, over which a search of the content index 106 is performed. The search engine 104 performs a search of items in the content index 106 and the tag index 108 to identify content items that contain the tags and keywords that the user selects, thereby producing a result set of content items for presentation to the user. On the basis of the content items contained in the result set, the tag ranker 112 produces a weights set of tags for presentation to the user. Accordingly, the user is presented with a set of tag suggestions on the basis of the content items that are responsive to a prior search.

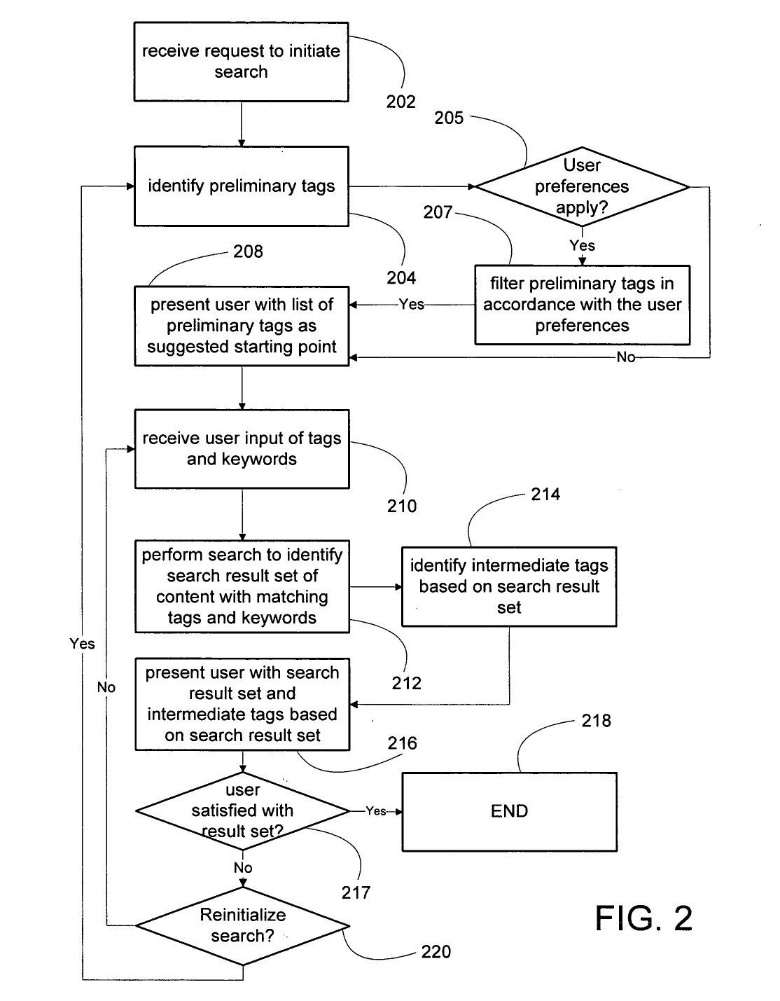

FIG. 2 presents a flow diagram illustrating one embodiment of a method for processing a search request using adaptive content categorization. According to FIG. 2, a search provider receives a request to initiate a search, step 202, and the search provider identifies preliminary tags, step 204. A tag ranker of the search provider may identify preliminary tags according to a measure of each tag's popularity, such as by the number of content items having a given tag associated with it or by the number of users associated with the tag. Alternatively or additionally, the tag ranker may identify preliminary tags according to a measure of each tag's historical popularity during a recent time period, such as during the past 1 hour, 1 day, etc. Alternatively, or in conjunction with the foregoing, the tag ranker may set a weight (e.g., popularity) for a given tag as a function of the popularity of the content item (e.g., web page, RSS feed, etc.) with the given tag is associated and the number of user that tagged the content item with the given tag. Still further, preliminary tags may be identified through the use of human editors, interest derived from past searches of a given user and browsing behavior over a set of tags for a given user.

In other embodiments, the search provider may identify preliminary tags without regard to measures of each tag's popularity, and may instead use a default set of preliminary tags. In still other embodiments, the search provider may provide a preliminary search result set and may identify preliminary tags based on the preliminary search result set. If necessary, a tag ranker may perform a stemming procedure to reduce the number of similar tags having the same root. For example, the tags “blog” and “blogs” may be combined into a single tag “blog.”

The search provider performs a check to determine whether any user preferences should apply, step 205, which the tag ranker may perform. If so, the search provider applies the user preferences to filter or otherwise limit the preliminary tags in accordance with the user preferences, step 207. For example, each registered user may have an associated set of personal tags with which the user has tagged content items. The search provider may alternatively combine one or more of the preliminary tags with one or more personal tags of the user. Regardless of whether the user has any user preferences, step 205, the search provider presents the user with one or more preliminary tags as a suggested starting point for a given search, step 208.

The search provider receives user input of tags and keywords, step 210. According to one embodiment, a user may select one or more tags, for example, by clicking on one or more buttons or hyperlinks associated with the tags. Once a given tag is selected, the given tag may be de-selected by an appropriate user action. The user may also input one or more keywords, such as via a text input box, and may remove one or more keywords from the same or another text input box. The user is not required to select any tags, as long as at least one keyword is selected. Similarly, the user is not required to enter any keywords, as long as at least one tag is selected.

The search provider performs a search to identify a result set of content with matching tags and keywords, step 212. The search engine queries the content index and tag index to identify content items having matching tags and keywords. Based on this search result set, the search provider identifies intermediate tags, step 214, and presents the user with the search result set and the intermediate tags based on the search result set, step 216. The search provider suggests intermediate tags in order that the user may refine a search using additional or different tags. The search provider may also present the user with a list of currently selected tags and keywords.

The search provider performs a check to determine whether the user is satisfied with the result set, step 217. If so, the method ends, step 218. If not, a check may be performed to determine if the user wishes to reinitialize the search process, step 220. If the user wishes to reinitialize the search, the search provider identifies one or more preliminary tags to beign the search process, step 204. If the check performed at step 220 evaluates to false, processing returns to step 210 with the user providing zero or more tags and zero or more keywords over which to execute a search, which may also be performed in conjunction with the result set. The user may continue to select or de-select one or more (or zero) tags and may select or de-select one or more (or zero) keywords from the currently selected tags and keywords to further refine a search, and the search provider continues to update the search result set and intermediate tags based on the search result set.

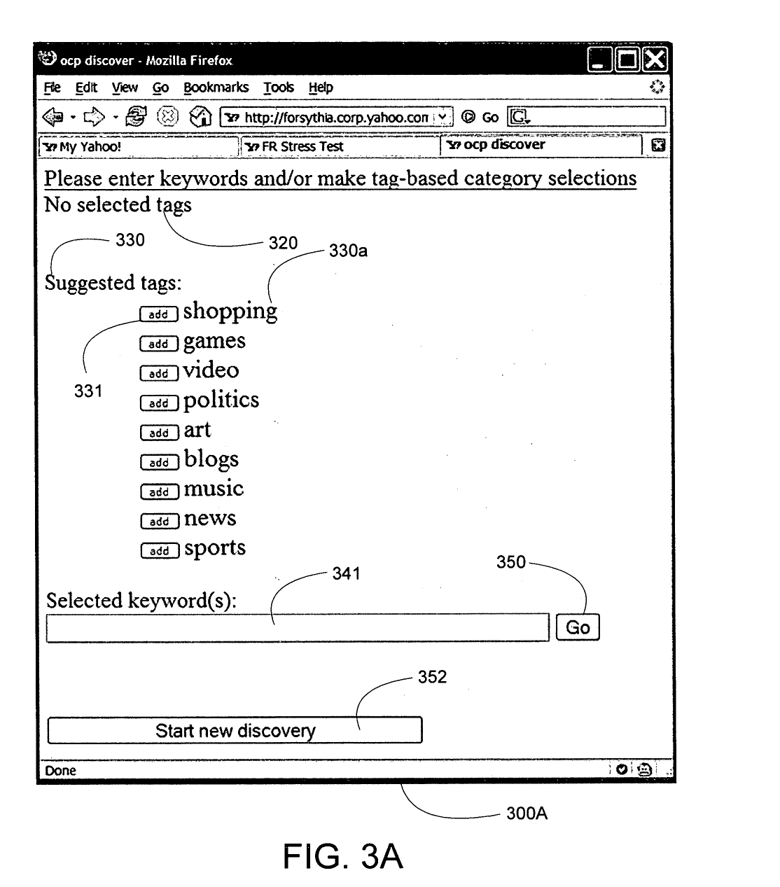

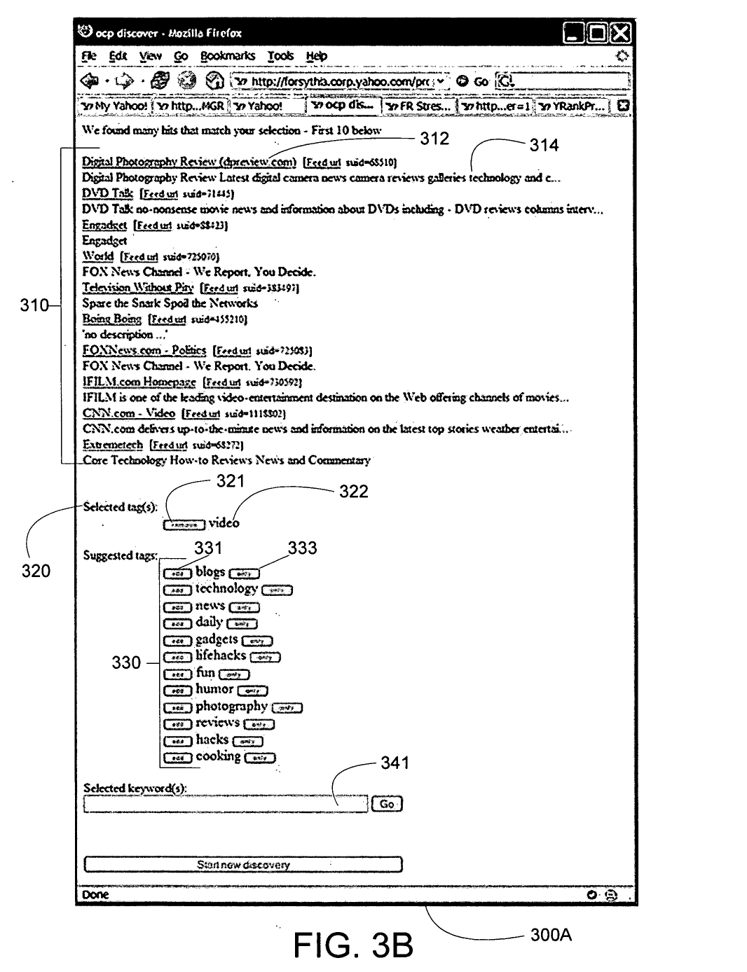

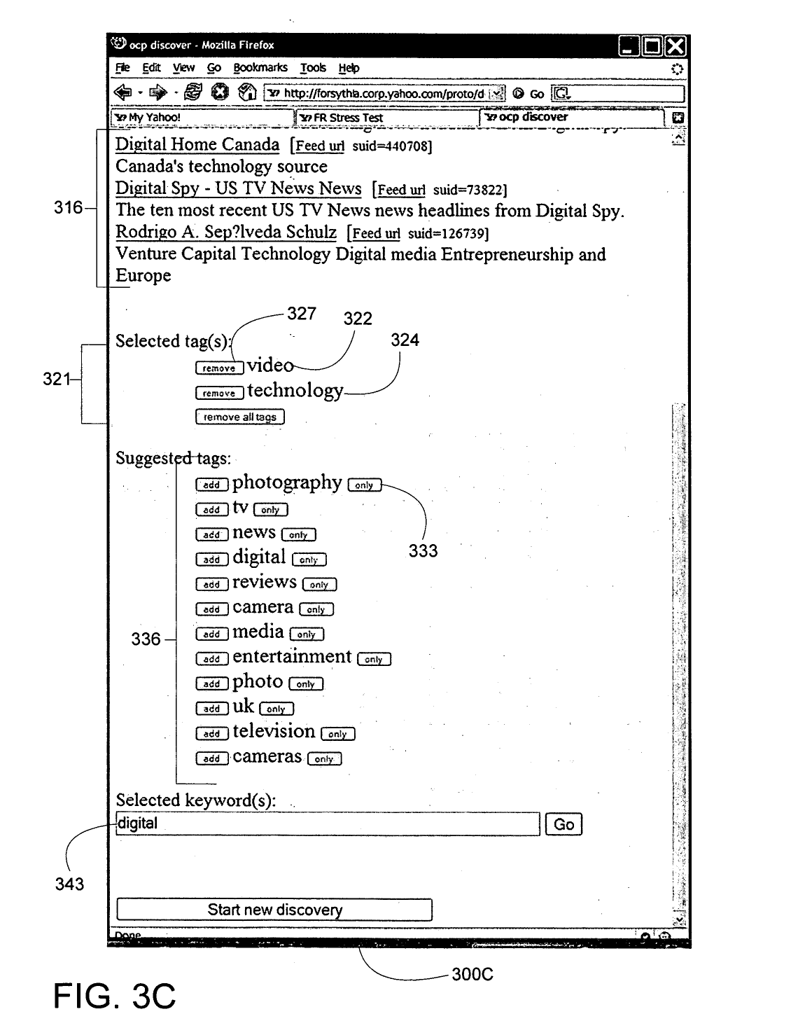

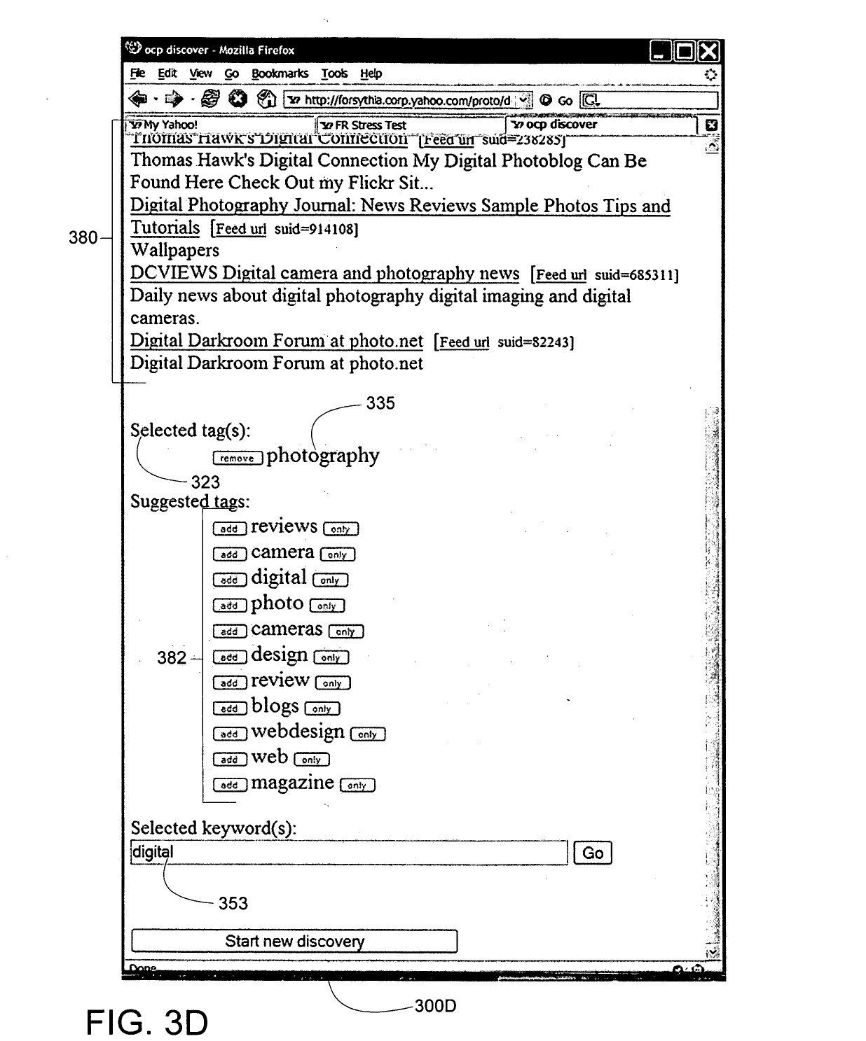

FIGS. 3A through 3D present screen diagrams illustrating a user interface for searching and retrieving content items using adaptive content categorization according to one embodiment of the present invention. Referring to FIG. 3A, a user interacting with a search provider may retrieve user interface 300A for initiating a search of content items indexed in a content index of the search provider. The search provider provides a set of preliminary tags to serve as suggested tags 330 for a starting point of a search. For example, a tag ranker of the search provider may identify the most popular tags in a tag index, by counting the number of content items indexed in the content index having a given tag or by counting the number of registered users who have the given tag in their personal tags. The search provider receives tags and keywords that the user inputs by using, for example, add tag controls 331 to select suggested tags 330 and keyword input box 341 to input keywords. The user may use a search control 350 to instruct the search provider to execute the current search using the selected tags and keywords. Alternatively, the user may use a reset control 352 to rest any selected keywords and tags, beginning a new search.

Referring now to FIG. 3B, the search provider displays via user interface 300B a search result set comprising content items 310, which may include links to content items 312 and corresponding descriptions 314. The search provider may also display a set of selected tags 320 including selected tag 322. The search result set of content items 310 includes content items that are associated with the selected tag 322 “video”. Based on the content items 310 in the result set, the search provider also displays a set of suggested tags 330. For example, a given content item has associated tags. A tag ranker of the search provider may identify tags associated with the given content item, and may rank each tag based on a measure of popularity or frequency in order to identify the most popular tags based on the search result set. The search provider suggests these most popular tags to the user to use as intermediate tags to refine the search. The user may remove a currently selected tag 322 using a remove tag control 321. The user may also select one or more additional suggested tags 330 using add tag controls 331. In addition to the foregoing, the user may select a given selected tag 330 to be the only tag, using an exclusive tag control 333. The user may furthermore add or remove one or more currently selected keywords using keyword input box 341.

Continuing with the present example with reference to FIG. 3C, the set of selected tags 321 includes the selected tags “video” 322 and “technology” 324 and the selected keyword includes the selected keyword 343 “digital,” which represents the user adding the tag “technology” and the keyword “digital” to refine the initial search of FIGS. 3A and 3B. The search provider presents an updated search result set of content items 316 that includes content items having matching tags and keywords from the current set of selected tags 321 and the current set of selected keywords 343. Additionally, the search provider presents an updated set of suggested tags 336 on the basis of the updated search result set of content items 316. Note that user interface 300C includes remove tag control 327, which allows the user to remove a given tag from the set of currently selected tags 321.

Continuing the example and referring now to FIG. 3D, the set of selected tags 323 that the user interface 300D presents includes the selected tag 335 “photography” and the set of selected keywords includes the selected keyword 353 “digital,” which represents the user selecting the tag “photography” as an exclusive tag (or by removing tags “video” and “technology” and adding the tag “photography”) and keeping the keyword “digital” to refine the search. The search provider presents an updated search result set 380 that includes content items having matching tags and keywords from the current set of selected tags 323 and the current set of selected keywords 353. Additionally, the search provider presents an updated set of suggested tags 382 on the basis of the updated set of content items 380 in the search result set.

While the invention has been described and illustrated in connection with preferred embodiments, many variations and modifications as will be evident to those skilled in this art may be made without departing from the spirit and scope of the invention, and the invention is thus not to be limited to the precise details of methodology or construction set forth above as such variations and modifications are intended to be included within the scope of the invention.

We claim:

1. A method comprising:
receiving a request to initiate a search for content items previously indexed and associated with one or more tags by a community of users;
identifying a set of preliminary tags from an index of tags defined by the community, where each tag is associated with one or more content items;
receiving input from the user of at least one tag or keyword to update a current set of selected tags and keywords;
identifying a result set of content items having associated tags and keywords matching the current set of selected tags and keywords; and
presenting the result set of content items along with an intermediate set of tags to serve as a potential starting point for refining the search based on the tags associated with each of the content items in the result set.

2. A method according to claim 1, wherein identifying a set of preliminary tags is based on a measure of popularity each tag in the index of tags.

3. A method according to claim 1, wherein receiving input from the user of at least one tag or keyword includes adding or removing at least one tag or keyword from the current set.

4. A method according to claim 1, further comprising repeating receiving input from the user of at least one tag or keyword, identifying a result set of content items having associated tags and keywords matching the current set of selected tags and keywords, and presenting the result set of along with an intermediate set of tags to serve as a potential starting point for refining the search based on the tags associated with each of the content items in the result set.

5. A method according to claim 1, further comprising presenting a preliminary result set not based on any selected tags and keywords.

6. A system comprising:
an index of content items;
an index of tags, where each tag is associated with at least one content item; and
a search engine operative to identify a result set of content items based on matching tags selected by a user and to suggest tags for a user to select based on the result set.

7. A system according to claim 6, wherein a community of users defines the index of tags.

8. A system according to claim 6, further comprising a tag ranker operative to rank tags associated with content items.

9. A system according to claim 8, wherein the tag ranker ranks tags based on a measure of popularity of each tag.

10. A system according to claim 9, wherein popularity is measured by the number of users using a given tag, the number of users associating a given tag with a given content item, or the number of content items having a given tag associated with it.
